(19) United States
(12) Patent Application Publication
(10) Pub. No.: US 2024/0215471 A1
(43) Pub. Date: Jul. 4, 2024

(54) HANDHELD TURF CARE DEVICE, METHOD FOR PRODUCING A HANDHELD TURF CARE DEVICE, AND BAG FOR A HANDHELD TURF CARE DEVICE

(71) Applicant: GHG GOLFKONTOR HANDELS GMBH, Hamburg (DE)

(72) Inventor: Tim Peter GAGELMANN, Freiburg (DE)

(73) Assignee: GHG GOLFKONTOR HANDELS GMBH, Hamburg (DE)

(21) Appl. No.: 18/398,173

(22) Filed: Dec. 28, 2023

(30) Foreign Application Priority Data
Dec. 30, 2022 (DE) 10 2022 135 063.0

(51) Int. Cl. A01B 45/02

(52) U.S. Cl. CPC A01B 45/02

(57) ABSTRACT

A handheld turf care device for caring for care a turf on a golf course. The handheld turf care device includes a cylindrical roller portion having a lateral surface for smoothing a section of the turf, a piercing tool which is arranged at a first end of the cylindrical roller portion, and a punching tool which is arranged at a second end of the cylindrical roller portion. The cylindrical roller portion is provided as a handrest. The first end of the cylindrical roller portion is oriented opposite to the second end of the cylindrical roller portion.

### CROSS REFERENCE TO PRIOR APPLICATIONS

Priority is claimed to German Patent Application No. DE 10 2022 135 063.0, filed Dec. 30, 2022. The entire disclosure of said application is incorporated by reference herein.

### FIELD

The present invention relates to a handheld turf care device, to a method for producing a handheld turf care device, and to a bag for a handheld turf care device.

Tools for maintaining an area of turf, in particular for mowing, scarifying, edging, rolling or fertilizing, have previously been described in the prior art. Such tools are in some cases automated as robots or designed as hand-operated devices, wherein their size and design means that they must mostly be operated using both hands (lawnmower, scarifier, lawn roller, fertiliser spreader) or with the aid of a foot (edger).

Owing to the features of the game of golf, areas of turf on golf courses are subject to special requirements. These requirements in particular relate to the condition of the turf and hence to the care of the turf. Turf care on a golf course (greenskeeping) is in particular performed by a turf care specialist (greenskeeper) and in some cases also by golfers.

The roll of a golf ball on a golf course turf should be as even as possible in order for the game to be influenced to a relatively predictable extent by ground conditions.

The roll of a golf ball on golf course turf can be influenced by turf factors. Possible turf factors include, for example, uneven blade growth, excessive blade growth, or the alien growth of species other than the predefined turf plants (such as weeds). Maintaining uniform turf growth and preventing alien growth are turf care tasks.

Alien growth is usually inhibited and/or removed by the greenskeeper after detection. A greenskeeper generally users an extractor tool to remove alien growth.

Uniform turf growth also depends in particular on ground conditions. To determine the ground conditions as well as nutrient concentrations in the turf that may require improvement, the greenskeeper in particular takes and analyses soil samples. A soil sampling tool is generally used for this purpose.

The roll of a golf ball on golf turf can also be undesirably influenced by microtopologies of the turf. Such microtopologies are in particular localised and in some cases invisible depressions in the surface of the turf.

Microtopologies can develop as a consequence of the game itself, for example, due to golf balls hitting the green, in particular at a steep angle (pitch marks), and/or due to footprints, in particular on soft ground, and/or pest infestations (for example, with moles or voles). Repairing microtopologies is a turf care task.

The use of so-called pitchforks, which usually have two fork prongs and which are designed to repair a pitch mark, is known by golfers and greenskeepers. The fork of the pitchfork is thereby introduced into the turf in and around the pitch mark, and the movement of the fork in a vertical direction loosens and flattens the uneven turf so that, ideally, the repaired pitch mark no longer influences the ball roll.

Greenskeepers are familiar with a number of golf turf care tools which, in addition to mechanical devices, such as mowers, include repair tools for pitch marks, soil sampling tools, aerators or pluggers. These tools are optimised for their purpose and, because of their size, are mostly designed as two-handed tools (see, for example, https://sibeag.ch/gruenpflege/).

The objective of golf is to hit a golf ball into a series of holes in as few strokes as possible. Cups are always inserted in the holes. The cups are made of metal or plastic and are recessed into the ground so that the circular top edge ends approximately 1 inch (2.54 cm) below the sward and so that a golf ball rolling towards the cup falls therein. For turf care jobs/greenkeeping jobs such as sanding, and also for winter greens, cups are in particular temporarily covered with cup covers. The covers can, for example, be made of plastic or metal. The cup cover can optionally be topped with artificial grass. A cup cover covers the hole completely and is recessed into the ground by a predefined depth so that a golf ball rolls over the covered cup with ideally no change of direction. Removing a corresponding cover is challenging in that the cover cannot be gripped from outside. Some cup covers include small apertures which can be used for leverage to facilitate a lifting up of the cup. A temporary cover on a cup can in particular be lifted using a needle-like tool.

Tools for golf course turf care and golf course design have therefore previously been described which can be used by a greenskeeper and/or by a golfer. The greenskeeper must accordingly have ready to use a number of specialist devices for carrying out the turf care tasks.

DE 10 2021 100 020 A1 describes a handheld scarifier, in particular for groundwork on turf, having a motor, in particular an electric motor. The scarifier of DE 10 2021 100 020 A1 has no spacer devices, in particular wheels, and the scarifier has a scarifying device, in particular a scarifying roller, which comprises at least one disc cutter having at least two teeth, wherein the at least two teeth are disposed opposite each other.

DE 20 2019 106 971 U1 describes an equipment carrier for turf care comprising a support frame having tool attachment compartments for at least two turf treatment devices and having a predetermined working direction for the turf treatment devices, characterised in that the turf treatment devices are disposed on the support frame so that the turf treatment devices can be used in combination, wherein at least one irradiating or chemically acting turf treatment device is provided in combination with at least one further mechanical, irradiating or chemically acting turf treatment device, the turf treatment devices each having the same working width transversely to the predetermined working direction, and the support frame having a height adjustment mechanism for at least one of the turf treatment devices.

DE 10 2014 014 485 A1 describes a pitchfork with an integrated global positioning system, characterised in that the classic pitchfork is combined with a GPS.

There is thus a need for a portable multifunctional tool for carrying out various golf course turf care and golf course design tasks which can be operated as a handheld device.

### SUMMARY

An aspect of the present invention is to improve on the prior art.

In an embodiment, the present invention provides a handheld turf care device for caring for care a turf on a golf course. The handheld turf care device includes a cylindrical roller portion having a lateral surface for smoothing a section of the turf, a piercing tool which is arranged at a first end of the cylindrical roller portion, and a punching tool which is arranged at a second end of the cylindrical roller portion. The cylindrical roller portion is provided as a handrest. The first end of the cylindrical roller portion is oriented opposite to the second end of the cylindrical roller portion.

### BRIEF DESCRIPTION OF THE DRAWINGS

The present invention is described in greater detail below on the basis of embodiments and of the drawings in which:

FIG. 1 shows a schematic representation of a handheld turf care device;

FIG. 2 shows a bag for a handheld turf care device;

FIG. 3 shows steps for producing a handheld turf care device according to the present invention;

FIG. 4 shows a schematic representation of a handheld turf care device with a wooden cylindrical roller portion and a cutting aperture; and

FIG. 5 shows a partial section of an extractor tool.

### DETAILED DESCRIPTION

Through the arrangement of a roller portion, a piercing tool, and a punching tool, the operator, in particular a greenskeeper, can use the handheld turf care device according to the present invention to repair a pitch mark, to remove alien growth, to take a soil sample, and to lift up a temporary cup cover. The handheld turf care device can be operated with one hand. The handheld turf care device is portable. The handheld turf care device can also be referred to as pebble tool.

To smooth out a pitch mark, the greenskeeper/operator places the palm of one hand on the roller portion and rolls the cylindrical roller portion of the handheld turf care device over the section of turf which in particular contains the area to be repaired or a part of the area to be repaired. The muscular strength introduced into the ground at right angles to the turf via the rolling handheld turf care device leads to a uniform distribution of the differently compressed and/or raised soil and thus smooths out the area. If the section of turf initially worked on only contains a part of the area to be repaired, the roller portion can be shifted so that a further section of turf can be worked on at a second time.

The greenskeeper/operator can also use the piercing tool to repair a pitch mark. The operator in this case in particular uses the cylindrical roller portion of the handheld turf care device as a handrest and introduces the piercing tool, in particular not completely vertically oriented, into the area of turf to be repaired. A pitch mark in the form of a depression is in particular levelled out by pressing together the root system and soil under the pitch mark, thereby smoothing out the surface of the turf.

To remove alien growth, the operator in particular uses the cylindrical roller portion of the handheld turf care device as a handrest and introduces the punching tool of the turf care tool into the area of turf affected so as to remove an identified alien species from the turf.

To take a soil sample, the operator again in particular uses the cylindrical roller portion of the handheld turf care device as a handrest and introduces the punching tool into the turf at a sampling point. The operator can then remove the soil sample from the punching tool at the laterally located removal hole and send it in for analysis.

To lift up a temporarily inserted cup cover or cup, the operator again in particular uses the cylindrical roller portion of the handheld turf care device as a handrest and introduces the piercing tool, in particular not completely vertically oriented, into the cup cover or cup or guides it to an edge of the cup cover or cup, and removes the cup cover or cup by levering it up or by tilting the piercing tool in the cup cover or cup during a removal process, which is in particular carried out in the vertical direction.

The arrangement of the tools and functional portions allows for a one-handed use of the handheld turf care device for various golf course turf care and golf course design tasks, and in particular a use of the cylindrical roller portion as a roller portion or handrest.

In a further embodiment of the present invention, the roller portion can, for example, in particular have a smaller diameter than the other functional portions so that forces which have significant levelling effects on the turf can be introduced into the turf almost exclusively via the roller portion as part of the repair process.

A key concept of the present invention is based on the fact that a multifunctional tool for turf care is provided which combines a plurality of functional elements so that they each take on different functions in order to carry out various tasks.

A second aspect of the present invention provides a method for producing a handheld turf care device according to the first aspect.

A third aspect of the present invention provides a bag for a handheld turf care device according to the first aspect, wherein the bag is configured for the accommodation and secure transportation of the handheld turf care device, in that the bag can in particular be temporarily arranged on, for example, a belt of an operator, and wherein the bag can have a closure element for the secure accommodation of a handheld turf care device, and wherein the bag can have a reinforcing element to protect an environment, in particular from the punching tool and the piercing tool. The bag can in particular include a textile portion. The textile portion can in particular contain nylon. The closure element can in particular be a hook-and-loop closure. The closure element can additionally or alternatively be a snap fastener. The closure element can also be a button and a corresponding buttonhole.

The following terms are explained:

A “cylindrical roller portion” is in particular understood to be a roller-shaped rolling element. The rolling element can comprise a solid cylinder. The rolling element can additionally or alternatively comprise a hollow cylinder. A first part of the rolling element can comprise a solid cylinder and a second part a hollow cylinder.

The material of the cylindrical roller portion can include plastic. The material of the cylindrical roller portion can additionally or alternatively include metal. The material of the cylindrical roller portion can additionally or alternatively include wood.

The cylindrical roller portion can, for example, has a longitudinal extent that is oriented parallel to a central axis of the rolling element. The cylindrical roller portion can, for example, also have a transverse extent that is oriented orthogonally to the longitudinal extent. The longitudinal extent can, for example, be configured so that it projects on both sides beyond the palm of a hand laid transversely to the longitudinal extent. The longitudinal extent can, for example, be 15.7 cm to 18 cm. The transverse extent can, for example, be configured so that a force exerted on the rolling element as it rolls leads to a uniform smoothing of a rolled surface, in particular a section of turf.

The cylindrical roller portion can additionally or alternatively have a jacket. The jacket can in particular be configured to establish a better grip. The jacket can additionally or alternatively be configured for an additional turf care operation, for example, for aerating and/or marking a section of turf while smoothing the section of turf by rolling the cylindrical roller portion over the section of turf.

The transverse extent of the cylindrical roller portion can, for example, be 1.3 cm to 3 cm. The transverse extent of the cylindrical roller portion can, for example, be greater than the transverse extent of the piercing tool and greater than the transverse extent of the punching tool.

A “piercing tool” is in particular understood to be a cylinder that narrows towards an outer end. The piercing tool can, for example, in particular taper to a point at an outer end. The transverse extent of the piercing tool can, for example, be 0.25 cm to 1 cm.

The material of the piercing tool can include metal. The material of the piercing tool can additionally or alternatively include plastic. The material of the piercing tool can additionally or alternatively also include wood.

A “punching tool” is in particular understood to be a hollow cylinder. The punching tool can, for example, be configured for sampling. The punching tool can, for example, additionally or alternatively be configured for removing alien growth.

The punching tool can, for example, have a longitudinal extent and a transverse extent oriented orthogonally to the longitudinal extent. The longitudinal extent of the punching tool of a handheld turf care device according to the present invention can, for example, be oriented in the same direction as the longitudinal extent of the cylindrical roller portion. The transverse extent can, for example, be 20 mm to 22 mm and is in particular 7 mm to 8 mm smaller than the transverse extent of the cylindrical rolling surface.

The punching tool can, for example, have a predefined wall thickness. The wall thickness can, for example, in particular be chosen so that the punching tool can be introduced into the turf without any great effort by the greenskeeper/operator. The wall thickness of the punching tool can, for example, taper towards the outer end of the punching tool. Recesses can additionally or alternatively be disposed on the outer end of the punching tool.

In particular for the sampling function, the punching tool can have an elliptical aperture and/or a rectangular aperture. The elliptical and/or rectangular aperture can, for example, be disposed on the lateral surface of the punching tool. The peripheral region of the elliptical and/or rectangular aperture can include recesses.

The “cutting aperture” is understood to be an aperture of the punching tool which is guided into the turf for soil sampling or for removing alien growth and is disposed opposite the cylindrical rolling surface of a handheld turf care device according to the present invention and oriented orthogonally to the central axis.

The present invention is described in greater detail below under reference to exemplary embodiments as shown in the drawings.

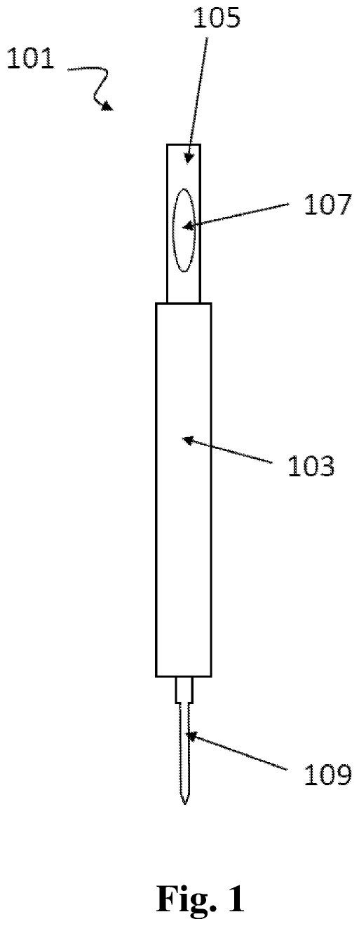

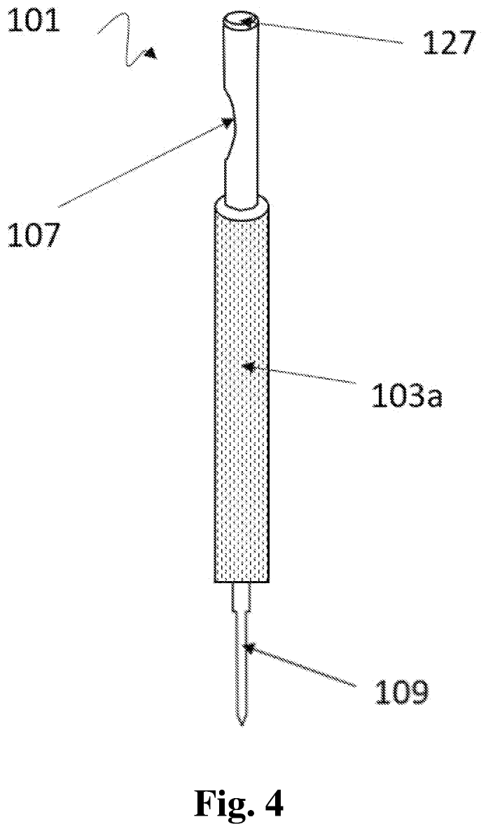

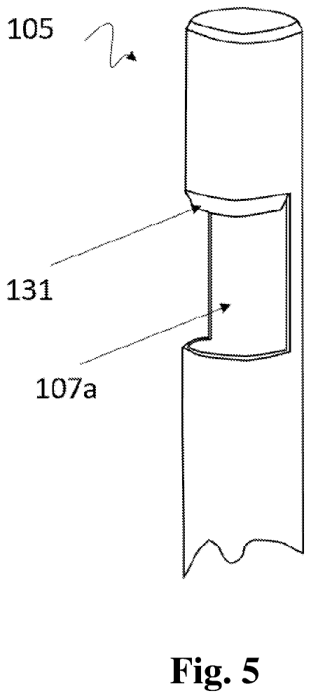

FIG. 1 shows a greenskeeper tool 101 as an exemplary embodiment of a handheld turf care device which has a green-smoothing portion 103 as an exemplary embodiment of a cylindrical roller portion, with a diameter of 3 cm and a length of 18 cm. The green-smoothing portion 103 comprises a solid wood cylinder 103a and is used by a greenskeeper to smooth out a pitch mark. The greenskeeper tool 101 also has a metal needle 109 as an exemplary embodiment of a piercing tool, which is disposed at a first end of the green-smoothing portion 103. The metal needle 109 has a length of 8 cm and tapers to a point at its end. The metal needle 109 has a diameter of 10 mm at the first end of the green-smoothing portion 103. The diameter of the metal needle 109 has the diameter of 10 mm over a length of 30 mm, after which the metal needle 109 has a thickness of 2.5 mm and a width of 7 mm over a length of 45 mm. The tapered portion of the metal needle 109 over the remaining 5 mm of the metal needle 109 is configured at an angle of 90°. The metal needle 109 contains stainless steel. The metal needle 109 is recessed into the end face of the first end of the green-smoothing portion 103 in the solid wood cylinder 103a and is thus fixedly connected to the green-smoothing portion 103. A conical transition can exist between the metal needle 109 and the green-smoothing portion 103. The greenskeeper uses the metal needle 109 to remove cup covers by using the green-smoothing portion 103 of the greenskeeper tool 101 as a handle and by pushing the metal needle 109 into a cup cover and levering the cover out of the cup. The greenskeeper tool 101 also has an extractor tool 105 as an exemplary embodiment of a punching tool, which is disposed at a second end of the green-smoothing portion 103. The extractor tool 105 is configured as a hollow metal cylinder made of stainless steel which has a diameter of 2.2 cm, a wall thickness of 2 mm, and a length of 17 cm. The extractor tool 105 is recessed into the end face of the second end of the green-smoothing portion 103 in the solid wood cylinder 103a of the green-smoothing portion 103 and is thus fixedly connected to the green-smoothing portion 103. An elliptical aperture 107 or rectangular aperture 107a is disposed on the lateral surface of the extractor tool 105. The elliptical aperture 107 or rectangular aperture 107a has a length of 40 mm in the axial direction and a depth of 11 mm in the radial direction. The distance from the first end of the elliptical aperture 107 or rectangular aperture 107a to the open end of the extractor tool 105 is 30 mm. The first end 129 of the elliptical aperture 107 or rectangular aperture 107a is designed to make cuts by virtue of a bend 131 in the peripheral region of part of the elliptical aperture 107 or rectangular aperture 107a at an angle of 40° in the radial direction of the extractor tool 105. See FIG. 5. The open end of the extractor tool 105 is designed as a cutting aperture 127 as is shown in FIG. 4. The cutting aperture 127 is designed to be bevelled across the diameter of the extractor tool 105. It can, however, also be planar in shape. Both the bevelled or planar cutting aperture 127 has a wall thickness taper so that the cutting edge thus created slides easily into grass, turf or soil. The greenskeeper uses the extractor tool 105 to firstly take soil samples, by using the green-smoothing portion 103 of the greenskeeper tool 101 as a handle and by pushing the cutting aperture 127 of the extractor tool 105 into an area of turf, pulling it out again, and then removing the punched-out sample from the elliptical aperture 107 or rectangular aperture 107a. The greenskeeper also uses the extractor tool 105 to remove weeds by using the green-smoothing portion 103 of the greenskeeper tool 101 as a handle, pushing the extractor tool 105 into an area of turf containing a weed, and then pulling the extractor tool 105 out from the turf along with the weed.

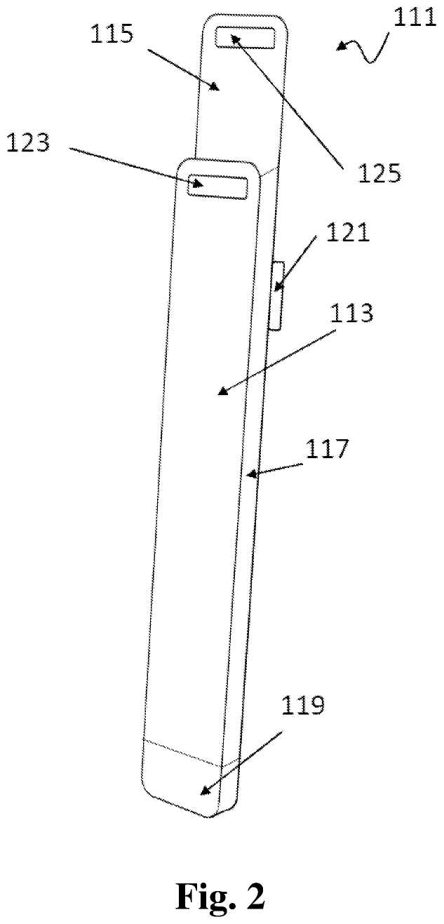

FIG. 2 shows a bag 111 for a greenskeeper tool 101 according to the present invention which comprises a first textile portion 115 made of nylon, to which is connected a second textile portion 117 made of nylon and a third textile portion made of nylon (not shown), wherein the second textile portion 117 and the third textile portion are connected to a fourth textile portion 113 made of nylon so that an insertion compartment into which a greenskeeper tool 101 can be introduced is stretched between the textile portions (113, 115, 117). The first textile portion 115 also includes an overlap on which a first hook-and-loop closure 125 is disposed which, after folding down the overlap, comes to rest on a second hook-and-loop closure 123 corresponding to the first hook-and-loop closure 125, so that the first hook-and-loop closure 125 and the second hook-and-loop closure 123 thereby form a releasable connection. The second hook-and-loop closure 123 is disposed on the fourth textile portion 113. The insertion compartment of the bag 111 is thereby closed, thus securing a greenskeeper tool 101 introduced into the insertion compartment against falling out. A reinforcing textile portion 119 is also disposed on the fourth textile portion 113 so that the metal needle 109 of a greenskeeper tool 101 introduced with the metal needle 109 at the front does not puncture the bag 111. A belt loop 121 is also disposed on the side of the first textile portion 115 oriented opposite the insertion compartment so that a greenskeeper can attach the bag 111 to a belt.

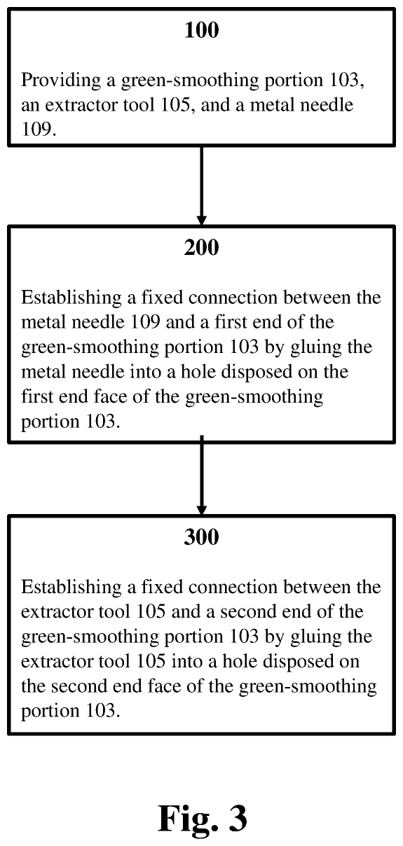

The method of the present invention is shown in FIG. 3. In a first step 100 of a method for producing a greenskeeper tool 101, a green-smoothing portion 103, an extractor tool 105, and a metal needle 109 are provided. Next, in a second step 200, a fixed connection is established between the metal needle 109 and a first end of the green-smoothing portion 103 by gluing the metal needle into a hole disposed on the first end face of the green-smoothing portion 103. In a third step 300, a fixed connection is established between the extractor tool 105 and a second end of the green-smoothing portion 103 by gluing the extractor tool 105 into a hole disposed on the second end face of the green-smoothing portion 103.

The present invention is not limited to embodiments described herein; reference should be had to the appended claims.

### LIST OF REFERENCE NUMERALS

101 Greenskeeper tool
103 Green-smoothing portion
103a Solid wooden cylinder
105 Extractor tool
107 Elliptical aperture
107a Rectangular aperture
109 Metal needle
111 Bag
113 Fourth textile portion
115 First textile portion
117 Second textile portion
119 Reinforcing textile portion
121 Belt loop
123 Second hook-and-loop closure
125 First hook-and-loop closure
127 Cutting aperture
131 Bend

What is claimed is:

1. A handheld turf care device for caring for care a turf on a golf course, the handheld turf care device comprising:
a cylindrical roller portion having a lateral surface for smoothing a section of the turf, the cylindrical roller portion being provided as a handrest;
a piercing tool which is arranged at a first end of the cylindrical roller portion; and
a punching tool which is arranged at a second end of the cylindrical roller portion, the first end of the cylindrical roller portion being oriented opposite to the second end of the cylindrical roller portion.

2. The handheld turf care device as recited in claim 1, wherein,
the cylindrical roller portion has a diameter,
the punching tool has a diameter, and
the diameter of the punching tool is smaller than the diameter of the cylindrical roller portion by 8 mm to 10 mm.

3. The handheld turf care device as recited in claim 2, wherein,
the diameter of the cylindrical roller portion is from 1 cm to 3 cm, and
the diameter of the punching tool is smaller than the diameter of the cylindrical roller portion by 20 mm to 22 mm.

4. The handheld turf care device as recited in claim 1, wherein,
the piercing tool has a diameter, a first end, and a second end which is oriented opposite to the first end,
the piercing tool is configured to taper towards the second end, and
the diameter of the piercing tool is from 0.25 cm to 1 cm.

5. The handheld turf care device as recited in claim 4, wherein the diameter of the piercing tool is from 0.25 cm to 0.7 cm.

6. The handheld turf care device as recited in claim 1, wherein at least one of,
the cylindrical roller portion is provided as a solid cylinder, and
the cylindrical roller portion has a length of from 15.7 cm to 18 cm.

7. The handheld turf care device as recited in claim 6, wherein at least one of,
the solid cylinder of the cylindrical roller portion is a solid wood cylinder (103a), and
the length of the cylindrical roller portion is 15.7 cm.

8. The handheld turf care device as recited in claim 1, wherein the punching tool is configured to punch out a section of the turf.

9. The handheld turf care device as recited in claim 8, wherein,
the punching tool comprises a hollow cylinder with a cutting aperture which is arranged opposite to the second end of the cylindrical roller portion, and
the hollow cylinder with the cutting aperture is used to punch out the section of the turf.

10. The handheld turf care device as recited in claim 8, wherein,
the punching tool is further configured to release a punched-out turf section.

11. The handheld turf care device as recited in claim 10, wherein,
the punching tool comprises an elliptical aperture, and
the punching tool is further configured to release the punched-out turf section at the elliptical aperture.

12. The handheld turf care device as recited in claim 11, wherein the elliptical aperture is arranged on a lateral surface of the punching tool.

13. A method for producing the handheld turf care device as recited in claim 1, the method comprising:
providing a cylindrical roller portion, a piercing tool, and a punching tool;
establishing a fixed connection between the piercing tool and a first end of the cylindrical roller portion; and
establishing a fixed connection between the punching tool and a second end of the cylindrical roller portion which is arranged opposite to the first end of the cylindrical roller portion.

14. A bag for the handheld turf care device as recited in claim 1, the bag comprising:
a first textile portion;
a second textile portion which is fixedly connected to the first textile portion;
an insertion compartment which is stretched between the first textile portion and the second textile portion, the insertion compartment being configured to accommodate the handheld turf care device;
a closure element which is arranged on the second textile portion, the closure element being configured to close the insertion compartment so that the handheld turf care device is prevented from falling out therefrom; and
a reinforcing element which is configured to protect an environment of the bag in which the handheld turf care device is accommodated from at least one of a punching tool and a piercing tool of the handheld turf care device.
